(19) United States
(12) Patent Application Publication
(10) Pub. No.: US 2025/0060941 A1
(43) Pub. Date: Feb. 20, 2025

(54) METHODS AND APPARATUS TO IMPROVE PERFORMANCE OF A COMPUTING DEVICE IMPLEMENTING AN EXPONENTIAL FUNCTION

(71) Applicant: Intel Corporation, Santa Clara, CA (US)

(72) Inventors: Bogdan Mihai Pasca, Toulouse (FR); Malladi Venkat Sriram Sastry, Bangalore (IN)

(73) Assignee: Intel Corporation, Santa Clara, CA (US)

(21) Appl. No.: 18/933,924

(22) Filed: Oct. 31, 2024

(30) Foreign Application Priority Data
Feb. 7, 2024 (IN) 202441008371

(51) Int. Cl. G06F 7/556; G06F 17/17

(52) U.S. Cl. CPC G06F 7/556; G06F 17/17

(57) ABSTRACT

Systems, apparatus, articles of manufacture, and methods are disclosed to improve performance of a computing device implementing an exponential function. An example apparatus includes interface circuitry to obtain an input, computer readable instructions, and programmable circuitry to instantiate range reduction circuitry to determine, based on the input, a first range reduced argument and an accuracy control value for an approximation of the exponential function of the neural network, and determine, based on the first range reduced argument, a second range reduced argument for the approximation of the exponential function, the second range reduced argument having a smaller data range than the first range reduced argument, and exponential configuration circuitry to compute an exponential value of the input based on the accuracy control value and an exponential value of the second range reduced argument.

### RELATED APPLICATION

This patent claims the benefit of Indian Provisional Patent Application No. 20/244,1008371, which was filed on Feb. 7, 2024. Indian Provisional Patent Application No. 20/244,1008371 is hereby incorporated herein by reference in its entirety. Priority to Indian Provisional Patent Application No. 20/244,1008371 is hereby claimed.

### FIELD OF THE DISCLOSURE

This disclosure relates generally to exponential functions and, more particularly, to method and apparatus to improve performance of a computing device implementing an exponential function.

### BACKGROUND

An exponential function is a mathematical function used to calculate a growth or decay of a set of data. The exponential function is represented by the equation f(x)=a^{x}, where “x” is a variable and “a” is a constant greater than zero. Exponential functions are used in modelling of many physical systems and are the basis for implementing activation functions and their derivatives in an artificial intelligence (AI) model. In AI models, activation functions convert raw output scores into probabilities by taking the exponential value of each output and normalizing the exponential values by dividing the sum of all the exponentials.

### BRIEF DESCRIPTION OF THE DRAWINGS

FIG. 1 is a block diagram of an example digital signal processing system in which example exponential implementation circuitry operates to reduce an amount of computation cycles an example arithmetic logic unit uses to implement an exponential function on an input.

FIG. 2 is a block diagram of an example implementation of the exponential implementation circuitry of FIG. 1.

FIG. 3 is an example flow diagram that represents example stages that may be performed by the exponential implementation circuitry of FIG. 2.

FIG. 4 is an example fixed point representation of a range reduced argument y.

FIG. 5 is an example lookup table used to look up exponential values for bit patterns of the most significant bits of the range reduced argument of FIG. 4.

FIG. 6 is an example term threshold table that illustrates a number of additional terms to be computed based on accuracy control values.

FIGS. 7-9 are flowcharts representative of example machine readable instructions and/or example operations that may be executed, instantiated, and/or performed by example programmable circuitry to implement the exponential implementation circuitry 102 of FIG. 2.

FIG. 10 is a block diagram of an example processing platform including programmable circuitry structured to execute, instantiate, and/or perform the example machine readable instructions and/or perform the example operations of FIGS. 7-9 to implement the exponential implementation circuitry 102 of FIG. 2.

FIG. 11 is a block diagram of an example implementation of the programmable circuitry of FIG. 10.

FIG. 12 is a block diagram of another example implementation of the programmable circuitry of FIG. 10.

In general, the same reference numbers will be used throughout the drawing(s) and accompanying written description to refer to the same or like parts. The figures are not necessarily to scale.

### DETAILED DESCRIPTION

An exponential function can be implemented in many ways.

Two of the approaches use floating point arithmetic or fixed point arithmetic. Floating point arithmetic and fixed point arithmetic are ways of representing and performing arithmetic operations on real numbers in computing. Floating point arithmetic is a numerical data type that allows a computer to handle values with fractional parts and a wide range of magnitudes. “Floating point” refers to the fact that the decimal point can “float” or be positioned anywhere within the number, enabling the representation of both large and small numbers.

Fixed point representation refers to using a fixed number of digits to represent the number's integer part and fractional part. Therefore, regardless of how large or small your number is, the fixed point representation will always use the same number of bits for each portion (e.g., integer portion and fractional portion). For example, if the fixed point format is base two with a total of 32 bits, and the integer portion stores 4 bits while the fractional portion stores 28 bits, then, based on a two's complement encoding, the largest number the fixed point representation could represent would be 0111.1111111111111111111111111111 (in base two) or 8−2⁻²⁸ (in base ten) and the smallest number would be 1000.0000000000000000000000000000 (in base two) or −8 (in base ten), where the first bit denotes the sign of the non-integer number in two's complement (e.g., “0” is positive and “1” is negative).

Floating point representations are traditionally used in

exponential functions because floating point numbers can represent a wide range of numbers. Therefore, software engineers, designing instructions for how a processor's arithmetic units are to perform, have developed and improved exponential architectures for floating point implementations. For example, there are many floating point exponential implementations available in various libraries, targeting many types of processors. However, even though floating point representation is dynamic in range and can represent numbers which are very high (e.g., 10⁶⁰) and very low (e.g., 10⁻⁶⁰), floating point implementation comes at cost, because to add, multiply, subtract, or divide two floating point numbers is not straightforward. There is hidden semantic and multiple steps for such math.

Adding, subtracting, multiplying, or dividing fixed point numbers is more simple, because the numbers have a fixed number of integers and a specific base (e.g., base 2, base 10, etc.). For example, 1.2+2.3 is just 1.2+2.3. There is no hidden semantic to execute in order to obtain the mathematical result of 3.5, as opposed to adding two floating point numbers which requires the execution of hidden semantic to obtain the sum. Therefore, fixed point arithmetic requires less power than floating point arithmetic because there are fewer steps and, thus, fewer computation cycles.

However, there are not as many fixed point exponential implementations and architectures as there are floating point exponential implementations and architectures. The problem with the lack of fixed point exponential implementations is that some hardware configurations operate more efficiently using fixed point arithmetic, but not all fixed point exponential implementations have been developed and improved. So even though latency is directly correlated to the amount of computation cycles required in a given application and, thus, is reduced when fixed point arithmetic is used rather than floating point arithmetic, improved implementations of floating point arithmetic can still be a better option than fixed point arithmetic.

Therefore, examples disclosed herein provide a fixed point exponential architecture that improves the efficiency of the hardware executing the exponential function and reduces latency relative to a floating point implementation. Examples disclosed herein provide a fixed point exponential architecture targeting digital signal processors (DSPs), which are special-purpose processors utilized for digital processing, such as digital processing of audio signals. Signals are often converted from analog form to digital form, manipulated digitally, and then converted back to analog form for further processing. Digital signal processing algorithms typically require a large number of mathematical operations to be performed quickly and efficiently on a set of data.

DSPs thus often incorporate specialized hardware to perform software operations for traditional digital signal processing that are often math-intensive and include operations such as addition, multiplication, multiply-accumulate (MAC), and shift-accumulate. DSPs also incorporate specialized hardware to perform neural network acceleration. Examples disclosed herein can be used in both traditional signal processing applications and neural network acceleration applications.

Examples disclosed herein improve the efficiency of the hardware executing a fixed point exponential function by determining a narrow range on which to evaluate the exponential of an input, and by determining a scaling factor—referred to as an accuracy control value-which is then used to reduce the computation requirement for approximating the exponential function of the input value. For example, the typical architecture for a floating point exponential function includes a first range reduction phase to reduce a range of the input value being evaluated by the exponential function, followed by an approximation phase to approximate the exponential function of the input value. Examples disclosed herein manipulate that original architecture by adjusting the approximation quality based on the reduced input range information in order to generate a low latency approximation of an input value in fixed point form while maintaining high accuracy. A low latency approximation refers to using fewer mathematical steps to approximate the exponential value of an input. For example, in a Taylor Series approximation, polynomial terms are added together for a certain value x, as shown in Equation A below.

$${e}^{x} = 1 + x + \frac{{x}^{2}}{2 !} + \frac{{x}^{3}}{3 !} + \frac{{x}^{4}}{4 !} + … \qquad Equation A$$

Examples disclosed herein reduce the number of polynomial terms needed to approximate the exponential function of x, but still maintain an accurate approximation. For example, the fewer polynomial terms used, the less accurate the approximation becomes. However, overall accuracy is maintained by using the reduced input range and the accuracy control value, which allows reducing the number of polynomial terms used to approximate the exponential function of the reduced argument such that after reconstruction, the accuracy of the exponential of x remains high. Examples disclosed herein reduce an amount of computational cycles needed to approximate the exponential function of x. A computational cycle refers to a single iteration of processing that a computer or computing system performs.

It is a measure of the computational work done by the CPU or other processing units in a given time frame. A computation cycle is typically tied to the clock speed of the CPU or processing unit. For example, if a CPU operates at 3 GHZ, the CPU can potentially perform 3 billion computation cycles per second.

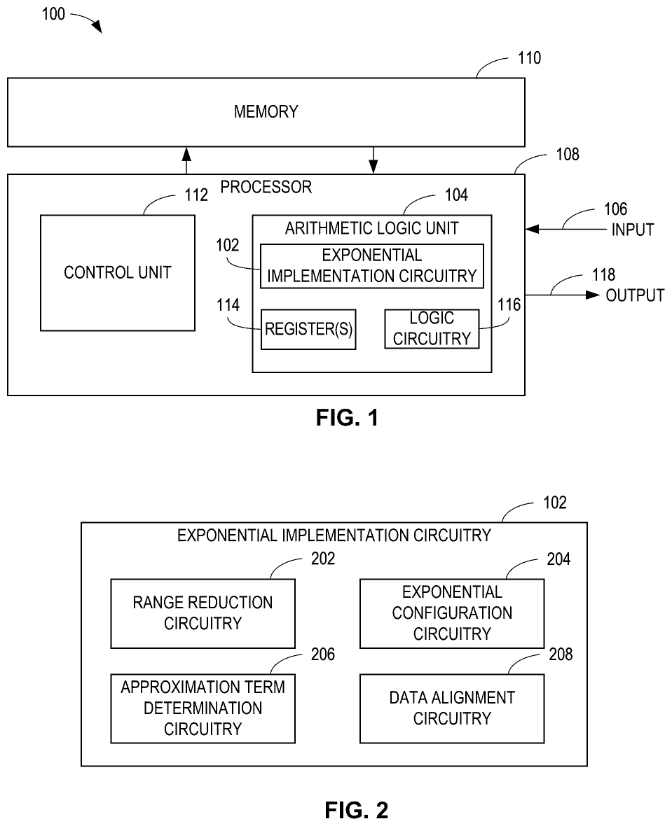

FIG. 1 is a block diagram of an example digital signal processing system 100 in which example exponential implementation circuitry 102 operates to reduce an amount of computation cycles an example arithmetic logic unit 104 needs to implement an exponential function on an input 106. The digital signal processing system 100 includes an example processor 108 and an example memory 110. The processor 108 includes the arithmetic logic unit (ALU) 104 and an example control unit 112. The ALU 104 includes the exponential implementation circuitry 102, example register(s) 114, and example logic circuitry 116.

In FIG. 1, the digital signal processing system 100 is a part of a processing platform that implements digital signal processing for that platform. In some examples, the processing platform may be implemented by Intel® Core™ Ultra 9 Processor, Intel® Core™ Ultra 7 Processor, and/or Intel® Core™M Ultra 5 Processor. Additionally and/or alternatively, the digital signal processing system 100 may be implemented on any type of processing platform that implements digital signal processing. In some examples, the digital signal processing system 100 is a digital signal processor (DSP) that is targeted for audio preprocessing for Speech Neural Networks, high performance audio, voice processing application, and AI vision use cases. For example, the digital signal processing system 100 may be implemented by Tensilica® HiFi 5 DSP, Tensilica® HiFi 4 DSP, Tensilica® HiFi 3 DSP, and/or Tensilica® HiFi 2 DSP. Additionally and/or alternatively, the digital signal processing system 100 may be implemented by any type of digital signal processor targeted for any type of use case.

In FIG. 1, the digital signal processing system 100 includes the processor 108 to execute instructions to process the input 106. The processor 108 may be specialized processor circuitry to implement neural network acceleration applications. In some examples, the input 106 corresponds to audio, such as music, speech, etc., images, video, etc. The processor 108 implements the control unit 112 and the ALU 104 to analyze the input 106 and generate an output 118. For example, the ALU 104 and control unit 112 may generate an output 118 that identifies speech included in input audio (e.g., input 106), an object identified in an input image (e.g., input 106), a person identified in an input video, an action identified in an input video, an indication of whether the input is a deepfake input (e.g., a deepfake video or a deepfake audio), etc. The control unit 112 directs executing of instructions, manages the operations of the processor 108, and controls the flow of data. For example, the control unit 112 directs the ALU 104 to perform certain functions on data, such as calculate the exponential value of an input.

In FIG. 1, processor 108 includes the ALU 104 to, among many other operations, perform an exponential function. The ALU 104 provides a standard set of arithmetic and logic functions, such as add, subtract, multiply, negate, increment, decrement, absolute value, AND, OR, Exclusive OR (XOR), Exclusive NOT (XNOR). The ALU 104 performs the arithmetic and logic functions on vectors of bits (zeros and ones). For example, the ALU 104 operates on binary data. Therefore, when the control unit 112 directs input data to the ALU 104 with instructions to perform a function, such as an exponential function, the ALU 104 has to determine the binary form of the input data first, before executing any functions. As described above, the binary data can be represented in floating point representation or a fixed point representation. In this example, the ALU 104 determines binary fixed point representations of input data before calculating arithmetic and logic functions.

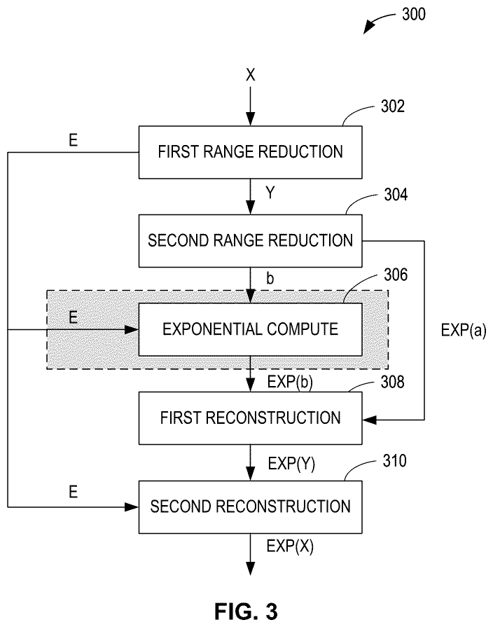

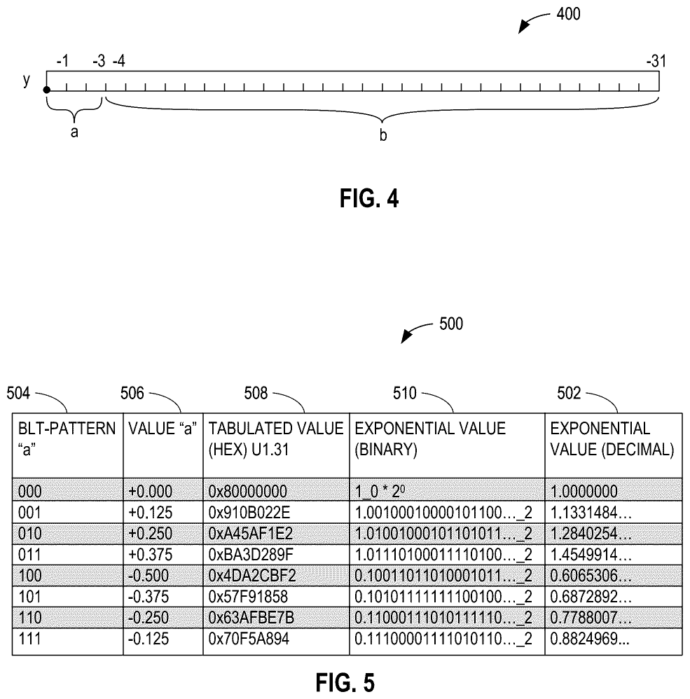

In FIG. 1, the ALU 104 includes the exponential implementation circuitry 102 to determine a first fixed point representation of an input that represents the input in binary, and then determines a second fixed point representation that represents a reduced range of the first fixed point representation whose exponential value can be calculated with accuracy. The exponential implementation circuitry 102 creates an architecture for implementing an exponential function. The exponential implementation circuitry 102 outputs a certain number of bits equal to the number of bits of the first fixed point representation. For example, the exponential implementation circuitry 102 creates a fixed point input to fixed point output implementation that maximizes the accuracy of the exponential function and allows integration into fixed point arithmetic datapaths executed on the DSP system 100. The output of the exponential implementation circuitry 102 is provided to either the register(s) 114 or the logic circuitry 116. The exponential implementation circuitry 102 is described in further detail below in connection with FIGS. 2 and 3.

For example, turning briefly to FIG. 3, an example flow diagram is illustrated that represents example stages 300 that may be performed by the exponential implementation circuitry 102 of FIGS. 1 and 2. In FIG. 3, at stage 302, the exponential implementation circuitry 102 receives an input (x) and performs a first range reduction on the input x. For example, the exponential implementation circuitry 102 applies a range reduction algorithm to the input x to generate a range reduced argument y and an accuracy control value E. The range reduced argument y and accuracy control value E are described in further detail below in connection with FIG. 2.

At stage 304, the exponential implementation circuitry 102 performs a second range reduction on the range reduced argument y. For example, the exponential implementation circuitry 102 further reduces the range reduced argument y based on splitting y into most significant bits (MSB) a and least significant bits (LSB) b. At stage 304, the exponential implementation circuitry 102 causes the logic circuitry 116 to determine the exponential value of a (exp(a)) and stores the exponential value of a in the one or more register(s) 114. The exponential value of a is described in further detail below in connection with FIG. 2.

At stage 306, the exponential implementation circuitry 102 determines the exponential value of b (exp(b)), based on the accuracy control value E. For example, the exponential implementation circuitry 102 causes the logic circuitry 116 to approximate the exponential value of b based on the accuracy control value E. The accuracy control value E controls an efficiency of the logic circuitry 116 in determining the exponential value of the input x, while also satisfying an accuracy threshold of the ALU 104. For example, the ALU 104 may have to satisfy an accuracy threshold when executing mathematical operations. The exponential value of b is described in further detail below in connection with FIG. 2.

At stage 308, the exponential implementation circuitry 102 uses the exponential value of a and the exponential value of b to determine the exponential value of the range reduced argument y. For example, to determine the exponential value of y, the exponential implementation circuitry 102 instructs the logic circuitry 116 to multiply the exponential value of a and the exponential value of b. The exponential of the range reduced argument y is described in further detail below in connection with FIG. 2.

At stage 310, the exponential implementation circuitry 102 uses the exponential value of y and the accuracy control value E to determine the exponential value of the input x. For example, to determine the exponential value of x, the exponential implementation circuitry 102 reconstructs the algorithm for the exponential value of the input x to be equal to the product of the exponential value of y and 2 to the power of the accuracy control value E. The reconstructed algorithm for the exponential value of x is described in further detail below in connection with FIG. 2.

After the exponential implementation circuitry 102 performs stage 310, the ALU 104 outputs the exponential value of the input x. In some examples, the ALU 104 stores the exponential value of the input x in memory 110.

Returning to FIG. 1, the ALU 104 includes the register(s) 114 to read and write data to the exponential implementation circuitry 102 and the logic circuitry 116. For example, the register(s) 114 store input values for logic circuitry 116 functions, where some of the input values are determined by exponential implementation circuitry 102. The register(s) 114 also store outputs from logic circuitry 116. The register(s) 114 also facilitate data transfer between the exponential implementation circuitry 102 and logic circuitry 116. The register(s) 114 may act as one or more accumulators that store intermediate results and final results of an operation performed by the logic circuitry 116. In some examples, the register(s) 114 comprise of addresses, where each address represents a section of the register and stores data in a certain amount of bits (e.g., 32 bits, 16 bits, etc.). In this example, the logic circuitry 116 operates on 32 bits and, thus, data is stored in 32 bits.

In FIG. 1, the ALU 104 includes the logic circuitry 116 to perform arithmetic and logic functions on values in fixed point representation. The logic circuitry 116 may include any number of logic and arithmetic components, such as logic gates, multipliers, adders, counters, lookup tables, etc. In some examples, the logic circuitry 116 takes operands (e.g., integer inputs such as x, y, a, b, E) from a register 114, produces a result, and puts the result back in the register 114. In some examples, the logic circuitry 116 receives instructions to execute a function on an operand. For example, the logic circuitry 116 receives instructions to calculate the exponential value of the second fixed point representation of input data. The instructions to calculate the exponential value of the second fixed point representation of input data may include instructions to use a lookup table, instructions to use a specific approximation technique, etc.

In FIG. 1, the memory 110 is a main memory that stores instructions, input data, and output data. For example, memory 110 stores instructions that the ALU 104 and control unit 112 are to use to process an input 106 and stores the information (e.g., input 106) that is to be processed. The ALU 104 and control unit 112 access the instructions and information from the memory 110 to perform arithmetic and logic functions in accordance with the instructions. The memory 110 of FIG. 1 is implemented by any memory, storage device and/or storage disc for storing data such as, for example, flash memory, magnetic media, optical media, solid state memory, hard drive(s), thumb drive(s), etc. Furthermore, the data stored in the memory 110 is in binary data, but could be in any data format such as, for example, comma delimited data, tab delimited data, structured query language (SQL) structures, etc. While, in the illustrated example, the memory 110 is illustrated as a single memory, the memory 110 and/or any other data storage devices described herein may be implemented by any number and/or type(s) of memories.

FIG. 2 is a block diagram of an example implementation of the

exponential implementation circuitry 102 of FIG. 1 to use a fixed point representation to determine an exponential value of an input. The exponential implementation circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the exponential implementation circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

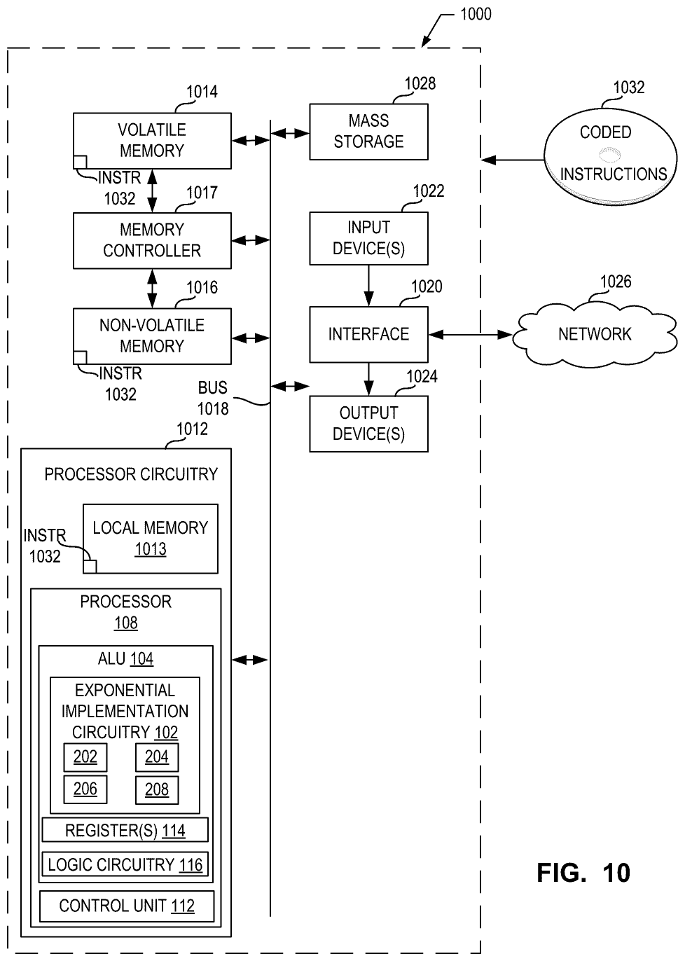

The exponential implementation circuitry 102 of FIG. 2 includes example range reduction circuitry 202, example exponential configuration circuitry 204, example approximation term determination circuitry 206, and data alignment circuitry 208. In some examples, the range reduction circuitry 202 is instantiated by programmable circuitry executing range reduction circuitry 202 instructions and/or configured to perform operations such as those represented by the flowcharts of FIGS. 9 and 10. In some examples, the exponential configuration circuitry 204 is instantiated by programmable circuitry executing exponential configuration circuitry 204 instructions and/or configured to perform operations such as those represented by the flowcharts of FIGS. 9 and 10. In some examples, the approximation term determination circuitry 206 is instantiated by programmable circuitry executing approximation term determination circuitry 206 instructions and/or configured to perform operations such as those represented by the flowcharts of FIGS. 9 and 10. In some examples, the data alignment circuitry 208 is instantiated by programmable circuitry executing data alignment circuitry 208 instructions and/or configured to perform operations such as those represented by the flowcharts of FIGS. 9 and 10.

In examples described herein, the exponential implementation circuitry 102 uses a fixed point representation, where the input is 32 bits and the output is 32 bits. In this example, the input format is S.4.28 and the output format is S13.19. The “S” in both the formats indicates a sign of the input and output (e.g., a negative or positive), the “4” and “13” denote the respective number of bits used to store the integer portions of the input and output, and the “”28” and “19” denote the respective number of bits used to store the fractional portions of the input and output. Given that the input format in this example is S4.28, the minimum input value that can be represented is negative eight (−8) and the maximum input value that can be represented is approximately positive eight (8). Throughout the description of the exponential implementation circuitry 102, reference will be made to this fixed point format. However, the exponential implementation circuitry 102 may use any type of fixed point representation.

In FIG. 2, the exponential implementation circuitry 102 includes the range reduction circuitry 202 to reduce a range on which the exponential function is approximated. As used herein, to reduce a range on which the exponential function is approximated means to reduce the input range of the exponential function. For example, suppose the ALU 104 is to calculate the exponential value of 1000 (e1000). Rather than directly inputting 1000 as the input to the exponential function, the range reduction circuitry 202 may extract some exponent scale (e.g., the accuracy control value E) from the input, and then determine a difference of the input (e.g., 1000) minus the product of the exponent scale and some other value (e.g., usually the natural logarithm of 2). The difference is referred to as the range reduced argument (y) and that range reduced argument is input to the exponential function (e^{y}). Finally, the exponential value of 1000 can be determined by multiplying the result of e^{y} by the 2 raised to the exponent scale value. Reducing an input range of a function allows approximation techniques to be used to approximate the function on the reduced input range, such that the final result of the approximation can be reconstructed starting from the result computed on the narrow input range. The range reduction circuitry 202 implements stages 302 and 304 of the example stages 300 described above and illustrated in FIG. 3.

In FIG. 2, the range reduction circuitry 202 may implement any type of range reduction technique to perform stage 302 (FIG. 3). In this example, the range reduction circuitry 202 may implement a first type of range reduction algorithm, which rewrites the input (x) as a sum of an integer multiple (E) of the natural logarithm of two (ln(2)) and a narrower input (y). The first type of range reduction algorithm is described by Equation 1:

$$x = y + E * ln ( 2 ) \qquad Equation 1$$

In Equation 1, x refers to the input, y refers to the narrower input derived from x, and E refers to an accuracy control value or an exponent scale. The accuracy control value E is an integer stored in a fixed point representation and determined based on multiplying the input by the inverse of the natural logarithm of two and rounding to the nearest whole number. For example, the accuracy control value E is described by Equation 2 below:

$$E = round ( x * \frac{1}{ln 2} ) \qquad Equation 2$$

The range reduction circuitry 202 rounds the product of Equation 2 to the nearest whole number to obtain the accuracy control value E, that will be used to calculate the exponential value of the least significant bits b and the exponential value of the input x at stage 310 (FIG. 3). For example, if the input is equal to four, the accuracy control value E will be 6, because the range reduction circuitry rounds the product of 5.77078 to the nearest whole number. In this example, the accuracy control value E has a minimum value of −12 and a maximum value of 12, because the minimum input is −8 and the maximum input is approximately 8.

In some examples, the range reduction circuitry 202 restricts the bits used to store the input and the inverse of the natural logarithm of two (e.g., in 1/ln2), prior to determining the accuracy control value E. For example, the (e.g., in range reduction circuitry 202 uses the values in the first (e.g., upper) 16 bits of the input and the values in first 16 bits of the inverse of the natural logarithm of two as the operands. For example, since the fixed point input format is “S4.28”, with a total of 32 bits, then the range reduction circuitry 202 reduces the input to have the format “S4.12”, where the bottom 16 bits were removed (e.g., dropped) from the fractional portion. Similarly, the range reduction circuitry 202 reduces the product of the inverse of the natural logarithm of two (e.g., 1/ln2) to be in the form of “S2.14”, where “S” is added to denote the same signedness as the input sign, the “2” denotes the integer portion, and the “14” denotes the fractional portion of the product.

The range reduction circuitry 202 restricts both the input and the inverse of the natural logarithm of two (e.g., 1/ln2) to the first 16 bits because the product of two 16-bit operands will hold on 32 bits and will have the output format of “S6.26”. The range reduction circuitry 202 rounds the product of the operands (e.g., of x and 1/ln2), stored in the fixed point format of “S6.26”, to the nearest integer by removing (e.g., dropping) the bottom 25 bits of the product, adding a rounding “1” to a round position, then shifting the round position to the right to reduce the total number of bits to 6 bits. As used herein, the “round position” is the bit to the right of the least significant bit in the integer portion of the product of the operands (e.g., of x and 1/ln2). For example, if the product is 101.1100010101010001111 (e.g., 5.770780163 in decimal), the rounding position is the position to the right of the decimal point: 101.1. The range reduction circuitry 202 outputs a 6-bit signed result, that is handled as a 5-bit sign result on the range of the accuracy control value E (e.g., the rounded product-which will be in the [−12,+12] interval) and writes it to the one or more register(s) 114. The range reduction circuitry 202 handles the 6-bit signed result as a 5-bit signed result because the input range is (−8, 8), and

$$\frac{\pm 8}{ln 2}$$

is equal to +11.59, which rounds to ±12.

Additionally and/or alternatively, the range reduction circuitry 202 does not shift the round position to the right to obtain the rounded accuracy control value E. In some examples, instead of adding a rounding “1” constant to the round position, the range reduction circuitry 202 adds the value from the round position bit as a carry-in (e.g., an extra addition) into the least significant bit of the 7-bit product. For example, after removing the 25 bits of the product, the product has 7 bits. The range reduction circuitry 202 adds the value in the round position bit as a carry-in into the least significant bit to ensure that the least significant bit position always stays zero. For example, the result of adding the value in the round position is some whole integer (e.g., E.0). The range reduction circuitry 202 outputs the final 5-bit accuracy control value E (e.g., the rounded product) and writes it to the one or more register(s) 114.

Additionally and/or alternatively, the range reduction circuitry 202 does not remove the 25 bits of the product when rounding the product to the nearest integer value. For example, the range reduction circuitry 202 instead operates on the 32 bit product directly by adding a constant corresponding to 2²⁵ (e.g., 0x02000000 in hexadecimal format) to the product, then shifting the result sum to the right by 26. The range reduction circuitry 202 outputs the final 5-bit accuracy control value E and writes it to the one or more register(s) 114.

After determining the accuracy control value E, the range reduction circuitry 202 can determine a first range reduced input y. As mentioned above, y is a narrower version of input of x. To determine the first range reduced input y, the range reduction circuitry 202 rewrites Equation 1 to solve for the narrower input y. Equation 3 below represents the re-written Equation 1.

$$y = x - E * ln ( 2 ) \qquad Equation 3$$

In Equation 3, x refers to the input, y refers to the narrower version of input x, and E refers to the accuracy control value. The range reduction circuitry 202 determines the product of the accuracy control value E and the natural logarithm of two (e.g., E*ln(2)). For example, the range reduction circuitry 202 causes the logic circuitry 116 to multiply the 5-bit accuracy control value E by a 32-bit value corresponding to the natural logarithm of two (e.g., ln2). The range reduction circuitry 202 recovers the bottom 32 bits of the product (e.g., E*ln2). For example, the product of a 5-bit term times a 32-bit term results in a 37-bit product. However, the range reduction circuitry 202 uses only the bottom 32 bits (e.g., a subset of least significant bits) from the product, regardless of whether the product actually produces 37 bits. This is due to the range of the produced argument y from Equation 3. For example, the subtraction produces a fractional argument y

$$( in [ - \frac{- ln 2}{2} , \frac{ln 2}{2} ] ) ,$$

and knowing that subtraction operates from right to left (e.g., similar to addition), it can be understood that it is unnecessary to produce the upper bits of x−E*ln(2). Therefore, the range reduction circuitry 202 does not produce all bits of E*ln(2). In some examples, one or more of the one or more register(s) 114 storing the product do/does not need to be used for this multiplication. For example, the range reduction circuitry 202 causes the logic circuitry 116 to use a low multiplication register and not a high multiplication register. For example, accuracy control value E gets extended to a 32-bit operand before the multiplication, the multiplication E*ln(2) produces a 64-bit result that his packed in two registers (MH, ML), where ML denotes the low multiplication register and stores bits 31 to 0 of the product, and MH denotes the high multiplication register that stores bits 63 to 32 of the product.

The range reduction circuitry 202 then determines the first range reduced input y by causing the logic circuitry 116 to subtract the product of E and natural logarithm of two from the input x. In some examples, the range reduction circuitry 202 negates the product of E and natural logarithm of two and adds the new product to the input value of x. In some examples, the range reduction circuitry 202 re-aligns the value of the input x with the format of the product of E*ln(2) prior to subtracting x from the product.

Data alignment refers to the arrangement of data in memory, and specifically deals with the issue of accessing data as proper units of information from memory: For example, assume two sets of data are to be stored in memory: data1=ab and data2=cdef. Memory cells will store the data |abcd| and |ef00|. However, to make accessing data1 and data2 easier, it is desirable for the memory cells to store the data as |ab00| and |cdef″ to represent data1 and data2. An alignment system introduces padding (the |00|) in order to align the data with the memory of the system, in accordance with whatever architecture is being used. In the example above, having padding (so the data is memory-aligned) can save CPU cycles in order to retrieve the data. This might have an impact on the execution performance of a program because of minor number of memory access. However, there are many other scenarios where memory alignment is useful or even needed. For example, some architectures might have strict requirements for how the memory can be accessed. In such cases, the padding helps to allocate memory fulfilling the platform constraints.

In some examples, the range reduction circuitry 202 stores the value of the first range reduced input y in the one or more register(s) 114. The range reduction circuitry 202 causes the first range reduced input y to be a value representable by the fixed point format of “S1.31”, where “1” denotes the integer portion of y and “31” denotes the fractional portion of y. In some examples, range reduction circuitry 202 further reduces the first range reduced input y. In some examples, the range reduction circuitry 202 further reduces the first range reduced input y because y is still in a range that is may be too wide for efficient polynomial approximation. Efficient polynomial approximation is an approximation of a function (e.g., the exponential function) by a polynomial using as few terms as possible in order to obtain an approximation accuracy of less than 1 units in the last place (ULPs). As used herein, a ULP denotes the weight of the least significant bit (e.g., fractional bit) of the output format. ULP is used as a measure of accuracy in numeric calculations.

In some examples, the range reduction circuity 202 does not further reduce the input y, and the exponential configuration circuitry 204 determines the exponential value of the current argument y, as described below in Equation 7.

The range reduction circuitry 202 further reduces the range of the range reduced argument y by identifying and selecting the most significant bits and the least significant bits of y. For example, the range reduced argument y can be rewritten as shown in Equation 4 below.

$$y = a + b \qquad Equation 4$$

In Equation 4, a refers to the most significant bits (MSB) of y, and b refers to the least significant bits (LSB) of y. For example, the range reduction circuitry 202 initializes a to be the most significant 3 bits of y, and initializes b to be the least significant 28 bits of y.

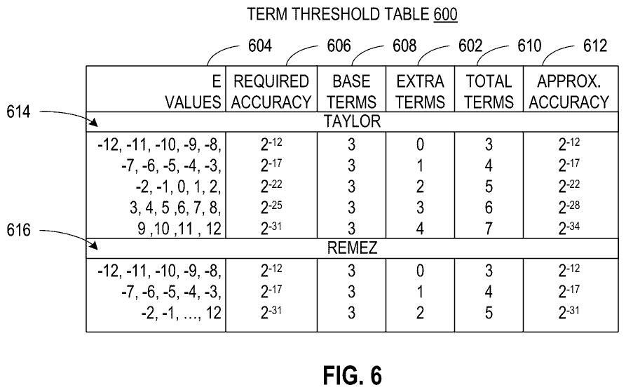

For example, turning briefly to FIG. 4, an example fixed point representation 400 of y is illustrated. In FIG. 4, the fixed point representation 400 depicts the 31 bits in the fractional portion of y, because y is between decimal values of [−0.35, 0.35] and the one bit integer portion of y does not store or represent any values.

In FIG. 4, the MSB and the LSB of y 400 are split, respectively, into a and b. For example, a is depicted as including the 3 leftmost bits of y 400 and b is depicted as including the 28 rightmost bits. In some examples, the range reduction circuitry 202 initializes a and b to be the 3 leftmost bits of y 400 and the 28 rightmost bits of y 400.

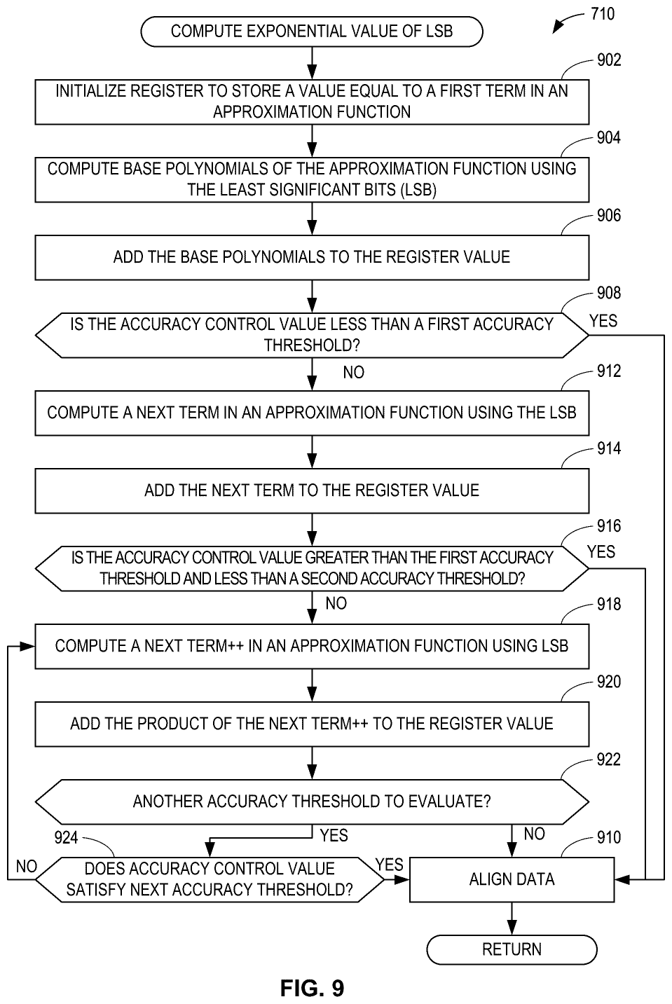

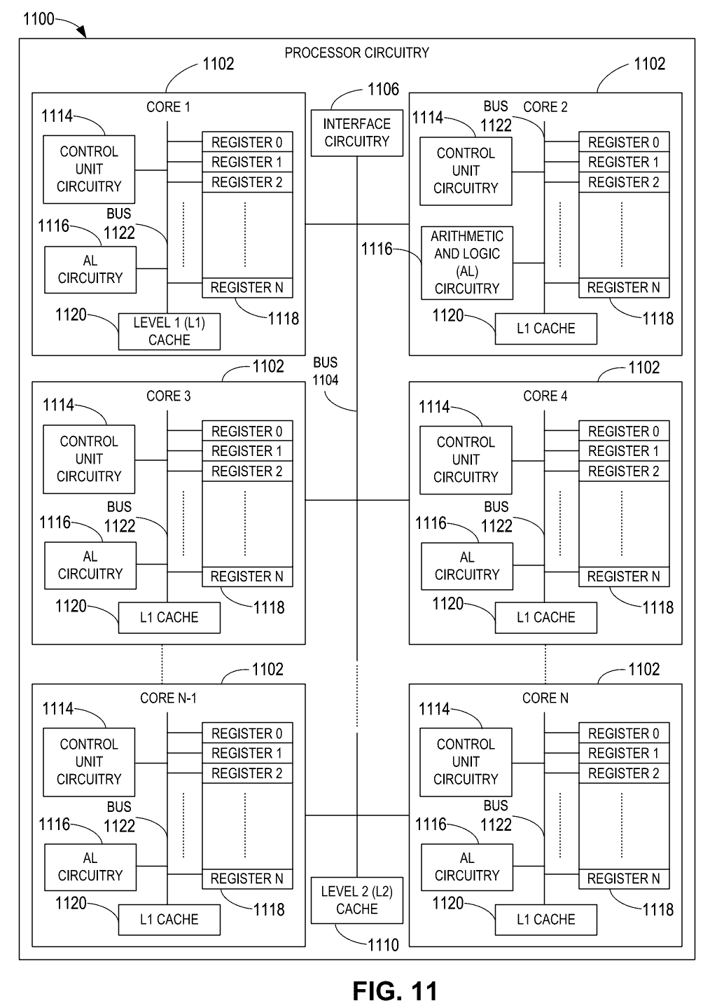

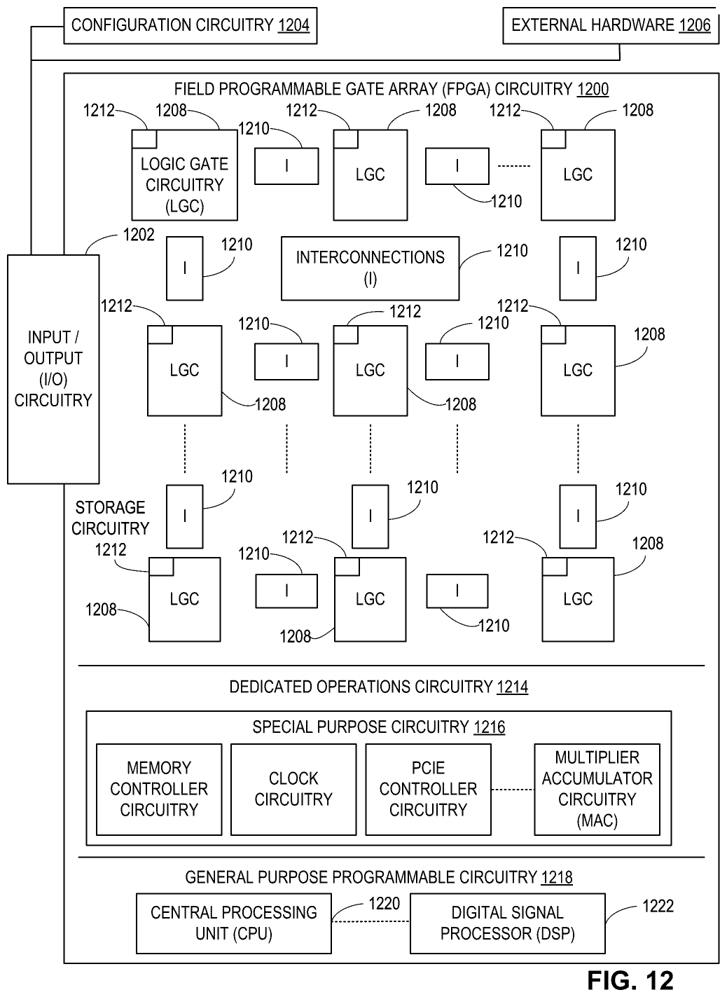

In some examples, the exponential implementation circuitry 102 includes means for determining, based on the input, a first range reduced argument and an accuracy control value for an approximation of the exponential function of a neural network. For example, the means for determining, based on the input, a first range reduced argument and an accuracy control value for an approximation of the exponential function of a neural network may be implemented by range reduction circuitry 202. In some examples, the range reduction circuitry 202 may be instantiated by programmable circuitry such as the example programmable circuitry 1012 of FIG. 10. For instance, the range reduction circuitry 202 may be instantiated by the example microprocessor 1100 of FIG. 11 executing machine executable instructions such as those implemented by at least blocks 702, 704 and 706 of FIG. 7 and blocks 802, and 804 of FIG. 8. In some examples, range reduction circuitry 202 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the range reduction circuitry 202 may be instantiated by any other combination of hardware, software, and/or firmware. For example, the range reduction circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining, based on the input, a first range reduced argument and an accuracy control value includes means for determining, based on the first range reduced argument, a second range reduced argument for the approximation of the exponential function. In some examples, the means for determining, based on the input, a first range reduced argument and an accuracy control value includes means for separating the first range reduced argument into most significant bits and least significant bits to determine the second range reduced argument.

Returning to FIG. 2, the exponential implementation circuitry 102 includes the exponential configuration circuitry 204 to determine the exponential values of the MSB (a) and the LSB (b) based on reconfiguring the exponential algorithm for a and b. For example, the exponential configuration circuitry 204 determines the exponential value of y based on determining the exponential values of a and b. In some examples, the exponential configuration circuitry 204 implements stages 304, 306, 308, and 310 of the example stages 300 described above and illustrated in FIG. 3.

Equation 5 describes the exponential value of y.

$${e}^{y} = {e}^{a} {e}^{b} \qquad Equation 5$$

In this example, determining the exponential values of a and b is more efficient than determining the exponential value of y because the value of y is larger than a and b, and more terms (e.g., approximation terms such as polynomial terms in a Taylor series, a Remez approximation, etc.) or iterations (e.g., iterations of CORDIC approximation) are needed for approximating an accurate exponential value of y than are needed to approximate an accurate exponential of a and/or b.

The exponential configuration circuitry 204 determines the exponential value of the MSB (a) based on a look-up table. A lookup table is an array of data that maps input values to output values, thereby approximating some function. For example, a lookup table can approximate the exponential function of a. A lookup table can be used to efficiently determine the exponential value of a because a consists of 3 bits. Therefore, the lookup table only needs to store exponential values for 8 bit patterns (e.g., 000, 001, 010, 011, 100, 101, 110, 111) and, thus, 8 input values.

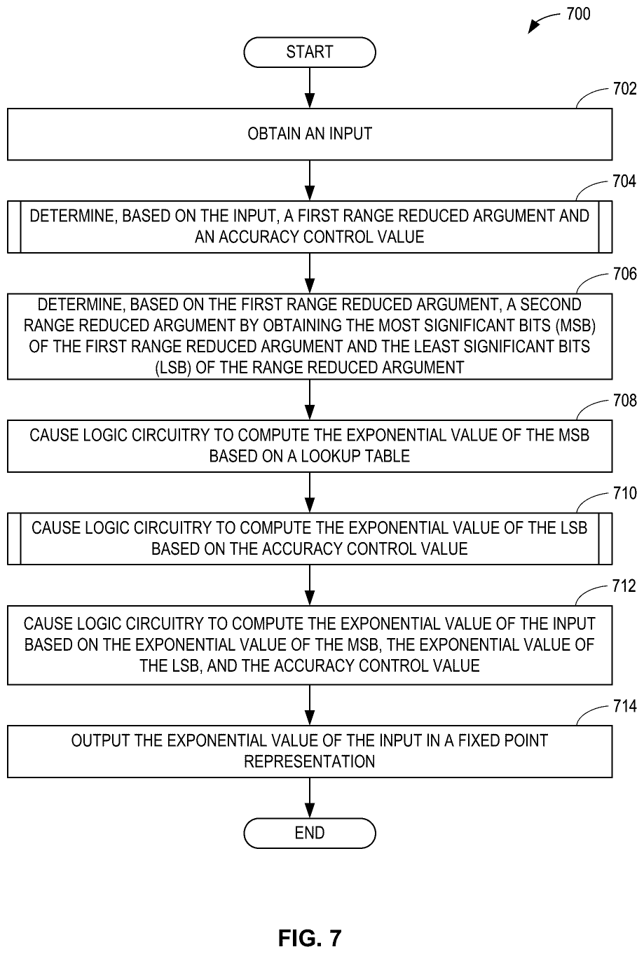

For example, turning briefly to FIG. 5, an example lookup table 500 is illustrated to lookup exponential values 502 for bit patterns 504 of a. The lookup table 500 includes the example exponential values 502, the example bit patterns 504, example decimal values 506, example hexadecimal values 508, and example binary based exponential values 510. In some examples, the lookup table 500 is stored in memory 110 and accessed by the exponential implementation circuitry 102 and/or the exponential configuration circuitry 204.

In FIG. 5, the bit patterns 504 are all the possible bit patterns of the 3 most significant bits of y. When a includes the 3 most significant bits of y, the lookup table 500 can be used to determine the exponential value of a.

In FIG. 5, the decimal values 506 correspond to the decimal values of the bit patterns 504 and, thus, the values of a. For example, when a, the 3 leftmost bits of y, have the bit pattern “001,” the 3 leftmost bits of y are equivalent to the decimal value “0.125.” The exponential configuration circuitry 204 uses the lookup table 500 to determine the exponential value of 0.125.

In FIG. 5, the hexadecimal values 508 correspond to the information stored in the lookup table for the output values, which is the closest fixed-point value to the value exp (a) that is representable on the output format. In this example, the hexadecimal values 508 are in the fixed point representation of unsigned (U) 1.31.

In FIG. 5, the binary exponential values 510 correspond to the exponential values of a, in a binary representation. For example, the binary exponential values 510 represent the exponential values of a in the fixed point representation of 1 integer bit and a number of fractional bits.

In FIG. 5, the exponential values 502 correspond to the exponential values of a, in decimal representation. The exponential configuration circuitry 204 may use the binary exponential values 510 and/or the hexadecimal values 508 to determine the exponential value of a.

Returning to FIG. 2, the exponential configuration circuitry 204 additionally and/or alternatively determines the exponential value of the MSB (a) based on Equation 6 below.

$${e}^{a} = {( {e}^{- {2}^{- 1}} )}^{{a}_{1}} {( {e}^{+ {2}^{- 2}} )}^{{a}_{2}} {( {e}^{+ {2}^{- 3}} )}^{{a}_{3}} \qquad Equation 6$$

In Equation 6, a is denoted as a={a₁, a₂, a₃}, where a₁ refers to the most significant bit of the three bits representing a, a₂ refers to the middle bit representing a, and a₃ refers the least significant bit of a. The weight of these three bits in the binary representation is a₁→−2⁻¹, a₂→2⁻², and a₃→2⁻³. The exponential configuration circuitry 204 reduces a number of inputs to tabulate (e.g., store in a lookup table), but increases a number of calculations used to determine the exponential value of a. For example, the exponential configuration circuitry 204 reduces the number of exponentials from 8 to 3 (e.g., e⁻²^{^{−1}}, e⁺²^{^{−2}}, e⁺²^{^{−3}}), but requires the logic circuitry 116 to perform multiplication (e.g., multiply the exponentials by the binary values of a₁, a₂, a₃). The exponential configuration circuitry 204 may implement either method (lookup table or Equation 6) to determine the exponential value of the MSB (a) of y. The exponential configuration circuitry 204 stores the exponential value of a in the one or more register(s) 114, and further determines the exponential value of b.

In some examples, the exponential configuration circuitry 204 implements stage 308 by using the exponential value of a and the exponential value of b to determine the exponential value of the range reduced argument y. For example, to determine the exponential value of y, the exponential configuration circuitry 204 multiplies the exponential value of a and the exponential value of b, as shown in Equation 7:

$${e}^{x} = {e}^{Eln ( 2 ) + y} = {e}^{ln ( {2}^{E} )} {e}^{y} = {2}^{E} {e}^{y} = {2}^{E} {e}^{a} {e}^{b} \qquad Equation 7$$

In Equation 7, x refers to the input value, E refers to the accuracy control value determined in Equation 2 above, y refers to the first range reduced argument determined in Equation 3 above, a refers to the MSB of y and the exponential of a can be determined by Equation 6 above or by using a lookup table, and b refers to the LSB of y. The exponential configuration circuitry 204 causes the logic circuitry 116 to shift the exponential value of y left or right based on the accuracy control value E. For example, the exponential configuration circuitry 204 causes the logic circuitry 116 to shift the exponential value of y left by E positions if E is positive and right by E positions if E is negative.

In some examples, the exponential implementation circuitry 102 includes means for computing an exponential value of an input based on an accuracy control value and a second range reduced argument. For example, the means for computing the exponential value of an input based on an accuracy control value and a second range reduced argument may be implemented by exponential configuration circuitry 204. In some examples, the exponential configuration circuitry 204 may be instantiated by programmable circuitry such as the example programmable circuitry 1012 of

FIG. 10. For instance, the exponential configuration circuitry 204 may be instantiated by the example microprocessor 1100 of FIG. 11 executing machine executable instructions such as those implemented by at least blocks 708, 710, 712 of FIG. 7 and block 902 of FIG. 9. In some examples, the exponential configuration circuitry 204 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the exponential configuration circuitry 204 may be instantiated by any other combination of hardware, software, and/or firmware. For example, the exponential configuration circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for computing an exponential value of an input based on an accuracy control value and a second range reduced argument includes means for computing an exponential value of the most significant bits based on a look-up table. In some examples, the means for computing an exponential value of an input based on an accuracy control value and a second range reduced argument includes means for determining a third exponential value for the second range reduced argument based obtaining the product of the first exponential value and the second exponential value and computing the exponential value of the input based on the third exponential value of the second range reduced argument and the accuracy control value. In some examples, the means for computing an exponential value of an input based on an accuracy control value and a second range reduced argument includes means for circuitry approximating the exponential value of the input using fixed point arithmetic and outputs the exponential value of the input in a fixed point representation.

In FIG. 2, the exponential implementation circuitry 102 includes the approximation term determination circuitry 206 to determine the exponential value of the LSB (b) based on the accuracy control value E. Additionally and/or alternatively, the approximation term determination circuitry 206 determines the exponential value of the range reduced argument (y) based on the accuracy control value E. Because mathematical operations require some precision, the approximation term determination circuitry 206 and/or more generally, the exponential implementation circuitry 102, has to satisfy an accuracy constraint when approximating the exponential value of an input. For example, the ALU 104 may bound an output of the logic circuitry 116 to satisfy an accuracy of 2⁻¹⁹ ULPs. Therefore, the approximation term determination circuitry 206 causes the logic circuitry 116 to output the exponential value of b or the exponential value of y with an error in the order of 2^{-19-E} (e.g., 2⁻⁷ when minimum value of E is −12) when the accuracy control value is negative, and an error in the order of 2^{-19-E} (e.g., 2⁻³¹ when the maximum value of E is 12) when the accuracy control value is positive. This shows that the accuracy for the exponential value of b (e^{b}) is dependent on the value of E.

The approximation term determination circuitry 206 may

instruct the logic circuitry 116 to use any type of approximation function to determine the exponential value of b and/or the exponential value of y. For example, the approximation term determination circuitry 206 may instruct the logic circuitry 116 to use a Taylor series approximation function, a Remez polynomial function, a Coordinate Rotation Digital Computer (CORDIC) function, etc. In a Taylor series approximation function, the polynomials are derived from a truncated Taylor series, illustrated in Equation 8 below.

$${T}_{n} ( x ) = 1 + x + \frac{1}{2 !} {x}^{2} + \frac{1}{3 !} {x}^{3} + \frac{1}{4 !} {x}^{4} + … + \frac{1}{n !} {x}^{n} \qquad Equation 8$$

In Equation 8, T refers to the approximation of the exponential of x, x refers to an input value (e.g., b), the exclamation mark (!) refers to a factorial notation, and n refers to a total number of polynomial terms used in the Taylor series. The more terms that are used in the Taylor approximation function, the more computational resources are required. However, the more terms used, the more accurate the approximation function is at determining the exponential value of b and/or y. The approximation term determination circuitry 206 uses the accuracy control value E to identify how many terms the logic circuitry 116 is to use when determining the exponential value of b and/or the exponential value of y.

In some examples, each approximation function offers a

different approximation quality (e.g., approximation accuracy). In a Taylor series approximation, the approximation quality depends on the terms that are truncated. For example, if the value of b is less than 2⁻³ (e.g., when a is equal to the 3 MSB, and b is equal to the 28 LSB), and the function that the Taylor series is to approximate is F(x)=e^{x}, then the number of terms that will satisfy an approximation error can be identified. Equation 9 below evaluates this approximation error when the first two terms in the Taylor series are used (1+x).

$$\vert F ( x ) - {T}_{1} ( x ) \vert < \vert + \frac{1}{2 !} {x}^{2} + \frac{1}{3 !} {x}^{3} + … \vert \qquad Equation 9$$

In Equation 9, x refers to b, where b is a value less than 2⁻³, and T₁(x) refers to the Taylor series polynomial T₁(x)=1+x. In some examples, when 2⁻³ is used as the value of “x”, the result of Equation 9 is an approximation error (in binary) of 1.000010110000010×2⁻⁷. Therefore, the upper bound for this approximation can be obtained by analyzing the upper term truncated part of the Taylor series (e.g., in this case

$$\frac{{x}^{2}}{2} = {2}^{- 7} ) .$$

In some examples, the approximation error for each added term of the Taylor series can be determined by adding another term and comparing the result to the difference between the value of the actual exponential function and the value of the approximation function (e.g., F(x)−T₁(x)). The approximation error gets better (e.g., smaller) for each additional term added.

The reconstruction of the exponential value of y, shown in Equation 7 above (e.g., e^{y}=e^{a}e^{b}) implies that in the worst case, the error produced in computing the exponential value of b (e.g., e^{b}), where b is less than 2⁻³, will be amplified by as much as 1.455. For example, the error may be multiplied (e.g., amplified) by as much as 1.455 because e^{a} has a largest value, for the largest input argument 0.011 of base 2 (e.g., 0.375 of base 10), of 1.455 (e.g., e^{0.375}=1.455). Therefore, the worst case error of eb must be to the order of 2⁻³¹/1.45.

Because the exponential value of a affects the approximation error, the approximation term determination circuitry 206 selects the number of terms based on the possible error produced by the Taylor series. The example approximation term determination circuitry 206 compromises between the number of operations used in the implementation of the approximation function, and the obtained accuracy.

In some examples, the approximation term determination circuitry 206 automatically uses the first three terms of the approximation function, regardless of the accuracy control value E. For example, the approximation term determination circuitry 206 causes the logic circuitry 116 to automatically compute the first two non-constant terms of the Taylor series polynomials, whether the value of E is −12 or 12, as shown in Equation 10.

$${T}_{2} ( b ) = 1 + b + \frac{1}{2 !} {b}^{2} \qquad Equation 10$$

In Equation 10, b refers to the value of the LSB of y, and T₂(b) refers to a degree-2 Taylor polynomial that approximates the exponential value of b. Depending on the accuracy control value E, the approximation term determination circuitry 206 determines a number of additional polynomial terms that are needed to be computed in order to meet the accuracy criteria. For example, the approximation term determination circuitry 206 compares the accuracy control value E to accuracy thresholds, where the accuracy thresholds define a minimum amount of polynomial terms that must be computed based on the value E.

For example, if the exponential implementation circuitry 102 implements a Taylor series approximation function, the approximation term determination circuitry 206 has five accuracy thresholds.

In some examples, if the exponential implementation circuitry 102 is implementing a CORDIC function to approximate the exponential value of y, the approximation term determination circuitry 206 has accuracy thresholds corresponding to a number of iterations of the CORDIC algorithm that the logic circuitry 116 is to apply. For example, the CORDIC approximation technique produces 1 digit of accuracy per iteration (e.g., per the number of times CORDIC values are computed). The approximation term determination circuitry 206 uses the accuracy control value of E to limit the number of iterations and, thus, reduce the total time for computing the exponential of y.

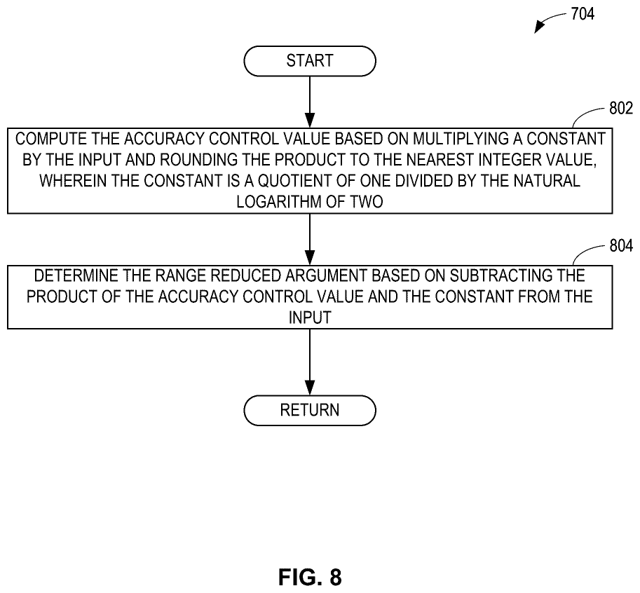

In some examples, if the exponential implementation circuitry 102 is implementing a Remez approximation function, the approximation determination circuitry 206 has three accuracy thresholds. For example, turning to FIG. 6, an example term threshold table 600 is shown that illustrates a number of extra terms 602 to be determined based on the accuracy control values 604.

In FIG. 6, the term threshold table 600 includes E values 604, required accuracy values 606, base terms 608, extra terms 602, total terms 610, and approximation accuracy values 612. The term threshold table 600 illustrates the extra terms 602 needed for a Taylor series approximation 614 and for a Remez approximation 616 in order to satisfy the required accuracy values 606.

In the term threshold table 600, the E values 604 are the possible accuracy control values derived from the minimum and maximum inputs of (−8, 8). The required accuracy values 606 are the worst case errors allowed for computing the exponential of the LSB b (e^{b}) and/or the exponential value of the range reduced argument y(e^{y}). The base terms 608 refer to a number of polynomial terms that are to be computed regardless of the E values 604. The extra terms 602 refer to a number of polynomial terms that are to be computed on top of the base terms 608 in order to satisfy the required accuracy values 606. The total terms 610 refer to a number of total polynomial terms that are to be computed for the range of the E values 604, which is sum of base terms 608 and extra terms 602. In this example, the approximation accuracy values 612 are the actual approximation error values between the exponential value of b and the approximation value of exponential of b, based on using the total terms 610 to approximate b. In some examples, the approximation accuracy values 612 may be similar to and/or equal to the actual approximation error values between the exponential value of y and the approximation value of the exponential of y.

The term threshold table 600 illustrates that in the Taylor series approximation 614, more terms are needed as the E values 604 increase. For example, E values 604 equal to or less than −8 and greater than or equal to −12 have to satisfy a first accuracy threshold of 2⁻¹², which can be satisfied using the number of base terms 608 (e.g., the first three terms of the Taylor series:

$$1 + b + \frac{1}{2 !} {b}^{2} )$$

and no extra terms 602. However, as the E values 604 increase (e.g., −7 to −3; −2 to 2, 3 to 8, and 9 to 12), the number of total terms 610 increase (e.g., 4, 5, 6, and 7) in order to satisfy the required accuracy values 606. For example, in a Taylor series approximation 614, when the accuracy control value E is greater or equal to −7 and less than or equal to −3, then the approximation term determination circuitry 206 has to satisfy a second accuracy threshold of 2⁻¹⁷, which can be satisfied using the number of base terms 608 (e.g., the first three terms of the Taylor series:

$$1 + b + \frac{1}{2 !} {b}^{2} )$$

and one extra term

$$( \frac{1}{3 !} {b}^{3} ) .$$

In the Taylor series approximation 614, when the accuracy control value E is greater than or equal to −2 and less than or equal to 2, then the approximation term determination circuitry 206 has to satisfy a third accuracy threshold of 2⁻²², which can be satisfied using the number of base terms 608 (e.g., the first three terms of the Taylor series:

$$1 + b + \frac{1}{2 !} {b}^{2} )$$

and two extra terms

$$( \frac{1}{3 !} {b}^{3} + \frac{1}{4 !} {b}^{4} ) .$$

In the Taylor series approximation 614, when the accuracy control value E is greater than or equal to 3 and less than or equal to 8, then the approximation term determination circuitry 206 has to satisfy a fourth accuracy threshold of 2⁻²⁵, which can be satisfied using the series approximation 614, when the accuracy control value E is greater than or number of base terms 608 (e.g., the first three terms of the Taylor series

$$1 + b + \frac{1}{2 !} {b}^{2} )$$

and the three extra terms

$$( \frac{1}{3 !} {b}^{3} + \frac{1}{4 !} {b}^{4} + \frac{1}{5 !} {b}^{5} ) .$$

Lastly, in the Taylor series approximation 615, when the accuracy control value E is greater than or equal to 9 and less than or equal to 12, then the approximation term determination circuitry 206 has to satisfy a fifth accuracy threshold of 2⁻³¹, which can be satisfied using the number of base terms 608 (e.g., the first three terms of the Taylor series:

$$1 + b + \frac{1}{2 !} {b}^{2} )$$

and four extra terms

$$( \frac{1}{3 !} {b}^{3} + \frac{1}{4 !} {b}^{4} + \frac{1}{5 !} {b}^{5} + \frac{1}{6 !} {b}^{6} ) .$$

The term threshold table 600 illustrates that in the Remez approximation 616, not as many terms are to be computed as the E values 604 increase, relative to the number of terms that are to be computed in the Taylor series approximation 614. In the Remez approximation 616, the approximation term determination circuitry 206 has three accuracy thresholds to evaluate rather than five. For example, when the accuracy control value E is greater than or equal to −2 and less than or equal to 12, then the approximation term determination circuitry 206 has to satisfy a third accuracy threshold of 2⁻³¹, which can be satisfied using the number of base terms 608 (e.g., the first three terms of the Remez) and two extra terms. The approximation term determination circuitry 206 has to satisfy a second accuracy threshold of 2⁻¹⁷ when E values are greater than or equal to −7 and less than or equal to −3, which can be satisfied using the number of base terms 608 (e.g., the first three terms of the Remez) and one extra term.

The term threshold table 600 illustrates that the accuracy of the approximation function is dynamic and depends on the number of polynomial terms that are computed. Conventional implementations of exponential approximations that target a floating point output format target a fixed output precision (e.g., number of mantissa bits). Unlike conventional implementations, the exponential implementation circuitry 102 dynamically changes the number of polynomial terms computed based on the accuracy required. As illustrated in the term threshold table 600, the accuracy depends on the value of the accuracy control value E, which is one of the two outputs (alongside y) of the first range-reduction stage 302. The objective of dynamically adjusting the accuracy of the approximation function is to reduce a latency on intervals of the input range for which a lower-degree polynomial approximation is sufficient.

Returning to FIG. 2, the approximation term determination circuitry 206 determines a number of terms to use to approximate the exponential function of b (and/or the exponential function of y), based on the accuracy control value E. In some examples, the approximation term determination circuitry 206 causes the logic circuitry 116 to approximate the exponential value of b using the identified number of terms. In some examples, the approximation term determination circuitry 206 causes the logic circuitry 116 to approximate the exponential value of y using the identified number of terms.

In some examples, the approximation term determination circuitry 206 stores the approximated exponential value of b in the one or more register(s) 114, to be accessed by the exponential configuration circuitry 204. For example, the exponential configuration circuitry 204 uses the exponential value of b to determine the final output: exponential value of the input x. In some examples, the approximation term determination circuitry 206 stores the approximated exponential value of y in the one or more register(s) 114, to be accessed by the exponential configuration circuitry 204. For example, the exponential configuration circuitry 204 uses the exponential value of y to determine the exponential value of the input x. The approximation term determination circuitry 206 implements stage 306 of the example stages 300 described above and illustrated in FIG. 3.

In some examples, the exponential implementation circuitry 102 includes means for determining a number of polynomial terms used to approximate an exponential value of the least significant bits of the range reduced argument. For example, the means for determining a number of polynomial terms used to approximate an exponential value of the least significant bits of the range reduced argument may be implemented by approximation term determination circuitry 206. In some examples, the approximation term determination circuitry 206 may be instantiated by programmable circuitry such as the example programmable circuitry 1012 of FIG. 10. For instance, the approximation term determination circuitry 206 may be instantiated by the example microprocessor 1100 of FIG. 11 executing machine executable instructions such as those implemented by at least block 710 of FIG. 7 and blocks 904, 906, 908, 912, 914, 916, 918, 920, 922, and 924 of FIG. 9. In some examples, the approximation term determination circuitry 206 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the approximation term determination circuitry 206 may be instantiated by any other combination of hardware, software, and/or firmware. For example, the approximation term determination circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining a number of polynomial terms used to approximate an exponential value of the least significant bits of the range reduced argument includes means for approximate a first exponential value for least significant bits of the second range reduced argument based on the number of polynomial terms identified by the accuracy control value.

In FIG. 2, the exponential implementation circuitry 102 includes the data alignment circuitry 208 to align the data stored in the one or more registers 114. For example, the data alignment circuitry 208 aligns the exponential value of a and the exponential value of b to a specific format. In some examples, the data alignment circuitry 208 aligns the product of Equation 7 (e.g., e^{x}) to a specific format. For example, the data alignment circuitry 208 aligns the product of Equation 7 to the fixed point representation of S13.19. The data alignment circuitry 208 may use any data alignment technique to align the exponential values in a specific format. For example, the data alignment circuitry 208 may use padding, bit shifting, etc., to align the data to a specific format. The data alignment circuitry 208 implements stage 310 of the example stages 300 described above and illustrated in FIG. 3.

In some examples, the exponential implementation circuitry 102 includes means for aligning data. For example, the means for aligning data may be implemented by data alignment circuitry 208. In some examples, the data alignment circuitry 208 may be instantiated by programmable circuitry such as the example programmable circuitry 1012 of FIG. 10. For instance, the data alignment circuitry 208 may be instantiated by the example microprocessor 1100 of FIG. 11 executing machine executable instructions such as those implemented by at least block 714 of FIG. 7 and block 910 of FIG. 9. In some examples, the data alignment circuitry 208 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the data alignment circuitry 208 may be instantiated by any other combination of hardware, software, and/or firmware. For example, the data alignment circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the exponential implementation circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example range reduction circuitry 202, the example exponential configuration circuitry 204, the example approximation term determination circuitry 206, the example data alignment circuitry 208, and/or, more generally, the example exponential implementation circuitry 102 of FIG. 2, may be implemented by hardware alone or by hardware in combination with software and/or firmware. Thus, for example, any of the example range reduction circuitry 202, the example exponential configuration circuitry 204, the example approximation term determination circuitry 206, the example data alignment circuitry 208, and/or, more generally, the example exponential implementation circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example exponential implementation circuitry 102 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the exponential implementation circuitry 102 of FIG. 2 and/or representative of example operations which may be performed by programmable circuitry to implement and/or instantiate the exponential implementation circuitry 102 of FIG. 2, are shown in FIGS. 7-9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory

(EEPROM), flash memory, etc.), volatile memory (e.g., Random Access

Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-9, many other methods of implementing the example exponential implementation circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to determine an exponential value of an input. The example machine-readable instructions and/or the example operations 700 of FIG. 7 begin at block 702, at which the exponential implementation circuitry 102 (FIG. 2) obtains input x. For example, the range reduction circuitry 202 (FIG. 2) obtains a numerical value, in fixed point representation, from the memory 110 (FIG. 1) and/or the control unit 112 (FIG. 1).

At block 704, the exponential implementation circuitry 102 reduces a range of the input x to obtain a range reduced argument y and an accuracy control value E. For example, the range reduction circuitry 202 applies a range reduction technique to reduce the range of the input x. The range reduction technique generates the first range reduced argument y and the accuracy control value E, as described in Equations 1 and 2 above in connection with FIG. 2.

At block 706, the exponential implementation circuitry 102 determines, based on the first range reduced argument y, a second range reduced argument by obtaining the most significant bits a (MSB a) of the first range reduced argument y and the least significant bits b (LSB b) of the first range reduced argument y. For example, the range reduction circuitry 202 further reduces the range of the range reduced argument y by identifying and selecting the most significant bits and the least significant bits of y using Equation 4 above. In some examples, the range reduction circuitry 202 initializes a to be the most significant 3 bits of y, and initializes b to be the least significant 28 bits of y, because y is a value representable by the fixed point format of “S0.31”.

At block 708, the exponential implementation circuitry 102 causes the logic circuitry 116 (FIG. 1) to compute the exponential value of the MSB based on a lookup table. For example, the exponential configuration circuitry 204 reconfigures the exponential algorithm for y based on Equation 5 above. In Equation 5, the exponential configuration circuitry 204 rewrites the exponential value of y as the product of the exponential value of a (MSB of y) and the exponential value of b (LSB of y). Therefore, the exponential configuration circuitry 204 causes the logic circuitry 116 to determine the exponential value of a. The logic circuitry 116 uses a lookup table, such as lookup table 500 (FIG. 5) to identify the exponential value of a. Additionally and/or alternatively, the logic circuitry 116 determines the exponential value of the MSB based on Equation 6 above.

At block 710, the exponential implementation circuitry 102 causes the logic circuitry 116 to compute the exponential value of the LSB based on the accuracy control value E. For example, the exponential configuration circuitry 204 causes the logic circuitry 116 to implement some approximation function to determine an exponential value of b. The approximation term determination circuitry 206 instructs the logic circuitry 116 to compute a specific number of terms of the approximation function, based on the accuracy control value E.

At block 712, the exponential implementation circuitry 102 causes the logic circuitry to compute the exponential value of the input x based on the exponential value of the MSB a, the exponential value of the LSB b, and the accuracy control value E. For example, the exponential configuration circuitry 204 causes the logic circuitry 116 to determine the exponential value of x based on Equation 7 above. In Equation 7, the exponential value of x is determined based on multiplying the exponential value of y (e.g., e^{a}e^{b}) by the exponent value of 2^{E}. In some examples, the exponential configuration circuitry 204 causes the logic circuitry 116 to shift the exponential value of y left or right based on the accuracy control value E.

At block 714, the exponential implementation circuitry 102 outputs the exponential value of the input in a fixed point representation. For example, the data alignment circuitry 208 (FIG. 2) aligns the data (e.g., the exponential value of the input x) to a predetermined fixed point format and stores the data in memory 110.

In some examples, the operations 700 do not include the operations of block 706 and 708. For example, the range reduction circuitry 202 does not determine a second range reduced argument. Instead, the exponential configuration circuitry 204 causes the logic circuitry 116 to compute the exponential value of the first range reduced argument y based on an approximation function and the accuracy control value E.

FIG. 8 is a flowchart representative of example machine readable instructions and/or example operations 704 that may be executed, instantiated, and/or performed by programmable circuitry to determine, based on the input, a first range reduced argument and an accuracy control value. The example machine-readable instructions and/or the example operations 704 of FIG. 8 begin at block 802, at which the exponential implementation circuitry 102 (FIG. 2) computes the accuracy control value E based on multiplying a constant by the input x and rounding the product to the nearest integer value, wherein the constant is a quotient of one divided by the natural logarithm of two. For example, the range reduction circuitry 202 causes the logic circuitry 116 to compute the accuracy control value E based on Equation 2 above.

At block 804, the exponential implementation circuitry 102 determines the range reduced argument based on subtracting the product of the accuracy control value E and the constant from the input x. For example, the range reduction circuitry 202 determines the value of the first range reduced argument y based on causing the logic circuitry 116 to subtract the product of E and the natural logarithm of two (e.g., E*ln(2)) from the input x.

The exponential implementation circuitry 102 returns the range reduced argument y and the operations 704 end.

FIG. 9 is a flowchart representative of example machine readable instructions and/or example operations 710 that may be executed, instantiated, and/or performed by programmable circuitry to cause the logic circuitry 116 to compute the exponential value of the least significant bits b (LSB) of the second range reduced argument based on the accuracy control value E. The example machine-readable instructions and/or the example operations 710 of FIG. 9 begin at block 902, at which the exponential implementation circuitry 102 (FIG. 2) initializes a register 114 (FIG. 1) to store a value equal to a first term in an approximation function. For example, the exponential configuration circuitry 204 (FIG. 2), depending on what type of approximation function is applied, causes a register 114 to store a value equal to 1, an initial coefficient, etc. In some examples, the exponential configuration circuitry 204 initializes the register 114 to store a 1 when the exponential configuration circuitry 204 applies a Taylor series approximation function (e.g., see Equation 8 above). In some examples, the exponential configuration circuitry 204 initializes the register 114 to store a predetermined coefficient when the exponential configuration circuitry 204 applies a Remez approximation function (e.g., see Equation 11 below). In some examples, the register 114 is an accumulating register that stores an accumulated value of the first term in the approximation function.

At block 904, the exponential implementation circuitry 102 computes base polynomials of the approximation function using the least significant bits (LSB). For example, the approximation term determination circuitry 206 (FIG. 2) causes the logic circuitry 116 (FIG. 1) to compute the base polynomial terms of an approximation function. In some examples, at block 904, the exponential implementation circuitry 102 computes base polynomials of the approximation function using the range reduced argument y. The base polynomials are predetermined and generally include the first three terms in an approximation functions (e.g., see Table 600 of FIG. 6). In some examples, the base polynomial terms of a Taylor series approximation function include the terms

$$b + \frac{1}{2 !} {b}^{2} ,$$

with the remaining term “+1” added in a later stage. In some examples, the base polynomials of a Remez approximation function are c₁b+c₂b², as shown in Equation 11.

$$P ( b ) = {c}_{0} + {c}_{1} b + {c}_{2} {b}^{2} \qquad Equation 11$$

In Equation 11, P(b) refers to the polynomial approximation of b, c₀ refers to an initial term, c₁ refers to a first order term, and c₂ refers to a second order term, where cₙ is a predetermined coefficient. When the exponential implementation circuitry 102 computes base polynomials of the approximation function using the range reduced argument y, the value y is substituted for the value of b in the Taylor series approximation function (Equation 10) and/or in the Remez approximation function (Equation 11).

At block 906, the exponential implementation circuitry 102 adds the base polynomials to the register value. For example, the approximation term determination circuitry 206 instructs the logic circuitry 116 to add the base polynomials to the accumulating register. In some examples, when the exponential implementation circuitry 102 is implementing a Taylor series approximation function, the approximation term determination circuitry 206 adds the sum of

$$b + \frac{1}{2 !} {b}^{2} ( or y + \frac{1}{2 !} {y}^{2} )$$

to the register value of 1. In some examples, when the exponential implementation circuitry 102 is implementing a Remez approximation function, the approximation term determination circuitry 206 adds the sum of c₁b+c₂b² (or c₁y+c₂y²) to the register value of c₀.

At block 908, the exponential implementation circuitry 102 determines whether the accuracy control value is less than a first accuracy threshold. For example, the approximation term determination circuitry 206 compares the accuracy control value E to a first accuracy control threshold, which is any value less than −7 (e.g., see Table 600 of FIG. 6).

At block 908, if the exponential implementation circuitry 102 determines that the accuracy control value E is less than a first accuracy threshold (e.g., block 908 returns a value YES), the exponential implementation circuitry 102 aligns the data (block 910). For example, if the range reduction circuitry 202 has determined that the accuracy control value E is −12, −11, −10, −9, or −8, then the approximation term determination circuitry 206 skips computing any remaining terms in the approximation function and instructs the data alignment circuitry 208 to align the register value to a specific format. In this example, the first accuracy threshold is the same for both Taylor series and Remez approximation functions.

At block 908, if the exponential implementation circuitry 102 determines that the accuracy control value E is greater than a first accuracy threshold (e.g., block 908 returns a value NO), then the exponential implementation circuitry 102 computes a next term in an approximation function using the LSB b (block 912). For example, if the range reduction circuitry 202 has determined that the accuracy control value E is −7 or greater, then the approximation term determination circuitry 206 instructs the logic circuitry 116 to compute the next order in the approximation function. In some examples, when a Taylor series is implemented, the approximation term determination circuitry 206 causes the logic circuitry 116 to compute

$$\frac{1}{3 !} {b}^{3} .$$

In some examples, when a Remez approximation is implemented, the approximation term determination circuitry 206 causes the logic circuitry 116 to compute c₃b³.

In some examples, at block 908, if the exponential implementation circuitry 102 determines that the accuracy control value E is greater than a first accuracy threshold (e.g., block 908 returns a value NO), then the exponential implementation circuitry 102 computes a next term in an approximation function using the range reduced argument y. In some examples, when a Taylor series is implemented, the approximation term determination circuitry 206 causes the logic circuitry 116 to compute

$$\frac{1}{3 !} {y}^{3} .$$

In some examples, when a Remez approximation is implemented, the approximation term determination circuitry 206 causes the logic circuitry 116 to compute c₃y³.

At block 914, the exponential implementation circuitry 102

adds the next term to the register value. For example, the approximation term determination circuitry 206 the logic circuitry 116 to update the accumulating register to be equal to either

$$register value + \frac{1}{3 !} {b}^{3} or register value + {c}_{3} {b}^{3} ,$$

depending on which approximation function is used. In some examples, the approximation term determination circuitry 206 the logic circuitry 116 to update the accumulating register to be equal to either

$$register value + \frac{1}{3 !} {y}^{3} or register value + {c}_{3} {y}^{3} ,$$

depending on which approximation function is used.

At block 916, the exponential implementation circuitry 102 determines whether the accuracy control value is less than a second accuracy threshold. For example, the approximation term determination circuitry 206 compares E to the second accuracy threshold, which is any value less than −2 and greater than −8 (e.g., −7, −6, −5, −4, −3).

At block 916, if the exponential implementation circuitry 102 determines that the accuracy control value E is less than a second accuracy threshold (e.g., block 916 returns a value YES), the exponential implementation circuitry 102 aligns the data (block 910). For example, if the range reduction circuitry 202 has determined that the accuracy control value E is −7, −6, −5, −4, −3, then the approximation term determination circuitry 206 skips computing any remaining terms in the approximation function and instructs the data alignment circuitry 208 to align the register value to a specific format. In this example, the second accuracy threshold is the same for both Taylor series and Remez approximation functions.

At block 916, if the exponential implementation circuitry 102 determines that the accuracy control value E is not less than a second accuracy threshold (e.g., block 916 returns a value NO), then the exponential implementation circuitry 102 computes a next term++in an approximation function using the LSB b (block 918). For example, if the range reduction circuitry 202 has determined that the accuracy control value E is −2 or greater, then the approximation term determination circuitry 206 instructs the logic circuitry 116 to compute the next order in the approximation function. In some examples, when a Taylor series is implemented, the approximation term determination circuitry 206 causes the logic circuitry 116 to compute

$$\frac{1}{4 !} {b}^{4} .$$

In some examples, when a Remez approximation is implemented, the approximation term determination circuitry 206 causes the logic circuitry 116 to compute c₄b⁴.

Additionally and/or alternatively, at block 916, if the exponential implementation circuitry 102 determines that the accuracy control value E is not less than a second accuracy threshold (e.g., block 916 returns a value NO), then the exponential implementation circuitry 102 computes a next term++ in an approximation function using the range reduced argument y. In some examples, when a Taylor series is implemented, the approximation term determination circuitry 206 causes the logic circuitry 116 to compute

$$\frac{1}{4 !} {y}^{4} .$$

In some examples, when a Remez approximation is implemented, the approximation term determination circuitry 206 causes the logic circuitry 116 to compute c₄y⁴.

At block 920, the exponential implementation circuitry 102 adds the next term++to the register value. For example, the approximation term determination circuitry 206 the logic circuitry 116 to update the accumulating register to be equal to either

$$register value + \frac{1}{4 !} {b}^{4} or register value + {c}_{4} {b}^{4} ,$$

depending on which approximation function is used. In some examples, the approximation term determination circuitry 206 the logic circuitry 116 to update the accumulating register to be equal to either

$$register value + \frac{1}{4 !} {y}^{4} or register value + {c}_{4} {y}^{4} ,$$

depending on which approximation function is used.

At block 922, the exponential implementation circuitry 102 determines whether there is another accuracy threshold to evaluate. For example, the approximation term determination circuitry 206 is provided with different accuracy thresholds based on the type of approximation function used, the required accuracy needed for the input, etc. In a Remez approximation function, the approximation term determination circuitry 206 is provided with three accuracy thresholds (e.g., see Table 600 of FIG. 6). In a Taylor series approximation function, the approximation term determination circuitry 206 is provided with five accuracy thresholds (e.g., see Table 600 of FIG. 6).

At block 922, if the exponential implementation circuitry 102 determines that there is another accuracy threshold to evaluate (e.g., block 922 returns a value YES), then the exponential implementation circuitry 102 determines whether the accuracy control value E satisfies the next accuracy threshold (block 924). For example, the approximation term determination circuitry 206 determines that a third accuracy threshold is any accuracy control value E less than 3 when a Taylor series is implemented.

At block 924, if the exponential implementation circuitry 102 determines that the accuracy control value E satisfies the next accuracy threshold (e.g., block 924 returns a value YES), control turns to block 910 where the exponential implementation circuitry 102 skips computing additional terms and aligns the data in the accumulating register. For example, if the approximation term determination circuitry 206 determines that the accuracy control value E is less than 3 (for Taylor series), then the approximation term determination circuitry 206 skips computing additional terms.

At block 924, if the exponential implementation circuitry 102 determines that the accuracy control value E does not satisfy the next accuracy threshold (e.g., block 924 returns a value YES), control returns to block 918 where the exponential implementation circuitry 102 computes a next term++ in an approximation function using the LSB b and/or using the range reduced argument y. For example, the approximation term determination circuitry 206 determines that for a Taylor series, the accuracy control value E is greater than 2 and, thus, needs to compute the next term

$$( e . g . , \frac{1}{5 !} {b}^{5} , \frac{1}{5 !} {y}^{5} )$$

to satisfy a required accuracy.

The operations 710 end when the accuracy control value E satisfies an accuracy threshold, and the exponential implementation circuitry 102 has aligned the data in the accumulating register to a specific format. In some examples, the specific format is S1.31. Additionally and/or alternatively, the specific format may be any fixed point format. In some examples, the aligned data in the accumulating register is the approximated exponential value of b, the LSB of y. In some examples, the aligned data in the accumulating register is the approximated exponential value of y. The approximated exponential value of b and/or the approximated exponential value of y satisfies a required accuracy and, thus, can be used to determine the exponential value of the input x.

FIG. 10 is a block diagram of an example programmable

circuitry platform 1000 structured to execute and/or instantiate the example machine-readable instructions and/or the example operations of FIGS. 7-9 to implement the exponential implementation circuitry 102 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example arithmetic logic unit 104, the example control unit 112, the example exponential implementation circuitry 102, the example registers 114, and the example logic circuitry 116.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIG. 2 as logic circuits to perform operations corresponding to those machine readable instructions. In some such examples, the circuitry of FIG. 2 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7-9. As such, the FPGA circuitry 1200 may be configured and/or structured to effectively instantiate some or all of the operations/functions corresponding to the machine readable instructions of the flowcharts of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 2 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide a fixed point exponential architecture that improves the efficiency of the hardware executing the exponential function and reduces latency relative to a floating point implementation. Disclosed systems, apparatus, articles of manufacture, and methods improve the efficiency of using a computing device by determining an accuracy control value, based on an input value, that is used to skip computing polynomial terms in an approximation function that are not needed to satisfy an accuracy. Skipping a computation of polynomial terms, while maintaining a required accuracy, reduces a number operations that are performed. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve performance of a computing device implementing an exponential function are disclosed herein. Further examples and combinations thereof include the following:

Example 1 includes an apparatus to perform an exponential function of a neural network, the apparatus comprising interface circuitry to obtain an input, computer readable instructions, and programmable circuitry to instantiate range reduction circuitry to determine, based on the input, a first range reduced argument and an accuracy control value for an approximation of the exponential function of the neural network, and determine, based on the first range reduced argument, a second range reduced argument for the approximation of the exponential function, the second range reduced argument having a smaller data range than the first range reduced argument, and exponential configuration circuitry to compute an exponential value of the input based on the accuracy control value and an exponential value of the second range reduced argument, wherein the accuracy control value identifies a number of polynomial terms used to approximate an exponential value of a portion of the second range reduced argument.

Example 2 includes the apparatus of example 1, wherein the range reduction circuitry is to multiply the accuracy control value by a natural logarithm of two to obtain a product, extract a subset of least significant bits of the product, and subtract the subset of least significant bits of the product from the input to determine the first range reduced argument.

Example 3 includes the apparatus of any one of examples 1 or 2, wherein the portion of the second range reduced argument is a first portion corresponding to least significant bits of the first range reduced argument, the exponential configuration circuitry is to compute an exponential value of a second portion of the second range reduced argument, corresponding to most significant bits of the first range reduced argument, based on a look-up table.

Example 4 includes the apparatus of any one of examples 1-3, wherein the exponential configuration circuitry is to approximate the exponential value of the input using fixed point arithmetic and outputs the exponential value of the input in a fixed point representation.

Example 5 includes the apparatus of any one of examples 1-4, wherein the range reduction circuitry is to determine the accuracy control value based on obtaining a product of the input and a constant, and rounding that product to a nearest integer.

Example 6 includes the apparatus of any one of examples 1-5, wherein the exponential configuration circuitry is to shift the exponential value of the second range reduced argument left or right by a number of positions equal to the accuracy control value to compute the exponential value of the input, wherein a left shift corresponds to a positive accuracy control value and a right shift corresponds to a negative accuracy control value.

Example 7 includes the apparatus of example 1, wherein the programmable circuitry is to instantiate approximation term determination circuitry to use a polynomial-based approximation function to approximate the exponential value of the portion of the second range reduced argument.

Example 8 includes the apparatus of example 1, wherein the exponential configuration circuitry is to compute the exponential value of the input based on the accuracy control value and an approximated exponential value of the first range reduced argument.

Example 9 includes the apparatus of example 1, wherein the programmable circuitry is to instantiate approximation term determination circuitry to use an iteration-based approximation function to approximate the exponential value of the portion of the second range reduced argument.

Example 10 includes a non-transitory machine readable storage medium to perform an exponential function of a neural network, the non-transitory machine readable storage medium comprising instructions to cause programmable circuitry to at least determine, based on an input, a first range reduced argument and an accuracy control value for an approximation of the exponential function of the neural network, determine, based on the first range reduced argument, a second range reduced argument for the approximation of the exponential function, the second range reduced argument having a smaller data range than the first range reduced argument, and compute an exponential value of the input based on the accuracy control value and an exponential value of the second range reduced argument, wherein the accuracy control value identifies a number of polynomial terms used to approximate an exponential value of a portion of the second range reduced argument.

Example 11 includes the non-transitory machine readable storage medium of example 10, wherein the instructions are to cause programmable circuitry to multiply the accuracy control value by a natural logarithm of two to obtain a product, extract a subset of least significant bits of the product, and subtract the subset of least significant bits of the product from the input to determine the first range reduced argument.

Example 12 includes the non-transitory machine readable storage medium of any one of examples 10 or 11, wherein the portion of the second range reduced argument is a first portion corresponding to least significant bits of the first range reduced argument, the instructions are to cause programmable circuitry to compute an exponential value of a second portion of the second range reduced argument, corresponding to most significant bits of the first range reduced argument, based on a look-up table.

Example 13 includes the non-transitory machine readable storage medium of any one of examples 10-12, wherein the instructions are to cause programmable circuitry to approximate the exponential value of the input using fixed point arithmetic and outputs the exponential value of the input in a fixed point representation.

Example 14 includes the non-transitory machine readable storage medium of any one of examples 10-13, wherein the instructions are to cause programmable circuitry to determine the accuracy control value based on obtaining a product of the input and a constant, and rounding that product to a nearest integer.

Example 15 includes the non-transitory machine readable storage medium of any one of examples 10-14, wherein the instructions are to cause programmable circuitry to shift the exponential value of the second range reduced argument left or right by a number of positions equal to the accuracy control value to compute the exponential value of the input, wherein a left shift corresponds to a positive accuracy control value and a right shift corresponds to a negative accuracy control value.

Example 16 includes the non-transitory machine readable storage medium of example 10, wherein the instructions are to cause programmable circuitry to use a polynomial-based approximation function to approximate the exponential value of the portion of the second range reduced argument.

Example 17 includes the non-transitory machine readable storage medium of example 10, wherein the instructions are to cause programmable circuitry to compute the exponential value of the input based on the accuracy control value and an approximated exponential value of the first range reduced argument.

Example 18 includes the non-transitory machine readable storage medium of example 10, wherein the instructions are to cause programmable circuitry to use an iteration-based approximation function to approximate the exponential value of the portion of the second range reduced argument.

Example 19 includes a system to perform an exponential function of a neural network comprising interface circuitry to obtain an input, programmable circuitry to determine a fixed point value from the input, determine, based on the fixed point value, a first range reduced argument and an accuracy control value for an approximation of the exponential function of the neural network, determine, based on the first range reduced argument, a second range reduced argument for the approximation of the exponential function, the second range reduced argument having a smaller data range than the first range reduced argument, and compute an exponential value of the fixed point value based on the accuracy control value and an exponential value of the second range reduced argument, wherein the accuracy control value identifies a number of polynomial terms used to approximate an exponential value of a portion of the second range reduced argument.

Example 20 includes the system of example 19, wherein the programmable circuitry is to shift the exponential value of the second range reduced argument left or right by a number of positions equal to the accuracy control value to compute the exponential value of the fixed point value, wherein a left shift corresponds to a positive accuracy control value and a right shift corresponds to a negative accuracy control value.

Example 21 includes the system of any one of examples 19 or 20, wherein the programmable circuitry is to multiply the accuracy control value by a natural logarithm of two to obtain a product, extract a subset of least significant bits of the product, and subtract the subset of least significant bits of the product from the fixed point value to determine the first range reduced argument.

Example 22 includes the system of any one of examples 19-21, wherein the portion of the second range reduced argument is a first portion corresponding to least significant bits of the first range reduced argument, the programmable circuitry is to compute an exponential value of a second portion of the second range reduced argument, corresponding to most significant bits of the first range reduced argument, based on a look-up table.

Example 23 includes the system of any one of examples 19-22, wherein the programmable circuitry is to approximate the exponential value of the fixed point value using fixed point arithmetic.

Example 24 includes the system of any one of examples 19-23, wherein the programmable circuitry is to determine the accuracy control value based on obtaining a product of the fixed point value and a constant, and rounding that product to a nearest integer.

Example 25 includes the system of example 19, wherein the programmable circuitry is to use a polynomial-based approximation function to approximate the exponential value of the portion of the second range reduced argument.

Example 26 includes the system of example 19, wherein the programmable circuitry is to compute the exponential value of the fixed point value based on the accuracy control value and an approximated exponential value of the first range reduced argument.

Example 27 includes the system of example 19, wherein the programmable circuitry is to use an iteration-based approximation function to approximate the exponential value of the portion of the second range reduced argument.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to perform an exponential function of a neural network, the apparatus comprising:
interface circuitry to obtain an input;
computer readable instructions; and
programmable circuitry to instantiate:
range reduction circuitry to:
determine, based on the input, a first range reduced argument and an accuracy control value for an approximation of the exponential function of the neural network; and
determine, based on the first range reduced argument, a second range reduced argument for the approximation of the exponential function, the second range reduced argument having a smaller data range than the first range reduced argument; and
exponential configuration circuitry to compute an exponential value of the input based on the accuracy control value and an exponential value of the second range reduced argument, wherein the accuracy control value identifies a number of polynomial terms used to approximate an exponential value of a portion of the second range reduced argument.

2. The apparatus of claim 1, wherein the range reduction circuitry is to:
multiply the accuracy control value by a natural logarithm of two to obtain a product;
extract a subset of least significant bits of the product; and
subtract the subset of least significant bits of the product from the input to determine the first range reduced argument.

3. The apparatus of claim 1, wherein the portion of the second range reduced argument is a first portion corresponding to least significant bits of the first range reduced argument, the exponential configuration circuitry is to compute an exponential value of a second portion of the second range reduced argument, corresponding to most significant bits of the first range reduced argument, based on a look-up table.

4. The apparatus of claim 1, wherein the exponential configuration circuitry is to approximate the exponential value of the input using fixed point arithmetic and outputs the exponential value of the input in a fixed point representation.

5. The apparatus of claim 1, wherein the range reduction circuitry is to determine the accuracy control value based on obtaining a product of the input and a constant, and rounding that product to a nearest integer.

6. The apparatus of claim 1, wherein the exponential configuration circuitry is to shift the exponential value of the second range reduced argument left or right by a number of positions equal to the accuracy control value to compute the exponential value of the input, wherein a left shift corresponds to a positive accuracy control value and a right shift corresponds to a negative accuracy control value.

7. The apparatus of claim 1, wherein the programmable circuitry is to instantiate approximation term determination circuitry to use a polynomial-based approximation function to approximate the exponential value of the portion of the second range reduced argument.

8. The apparatus of claim 1, wherein the exponential configuration circuitry is to compute the exponential value of the input based on the accuracy control value and an approximated exponential value of the first range reduced argument.

9. The apparatus of claim 1, wherein the programmable circuitry is to instantiate approximation term determination circuitry to use an iteration-based approximation function to approximate the exponential value of the portion of the second range reduced argument.

10. A non-transitory machine readable storage medium to perform an exponential function of a neural network, the non-transitory machine readable storage medium comprising instructions to cause programmable circuitry to at least:
determine, based on an input, a first range reduced argument and an accuracy control value for an approximation of the exponential function of the neural network;
determine, based on the first range reduced argument, a second range reduced argument for the approximation of the exponential function, the second range reduced argument having a smaller data range than the first range reduced argument; and
compute an exponential value of the input based on the accuracy control value and an exponential value of the second range reduced argument, wherein the accuracy control value identifies a number of polynomial terms used to approximate an exponential value of a portion of the second range reduced argument.

11. The non-transitory machine readable storage medium of claim 10, wherein the instructions are to cause programmable circuitry to:
multiply the accuracy control value by a natural logarithm of two to obtain a product;
extract a subset of least significant bits of the product; and
subtract the subset of least significant bits of the product from the input to determine the first range reduced argument.

12. The non-transitory machine readable storage medium of claim 10, wherein the portion of the second range reduced argument is a first portion corresponding to least significant bits of the first range reduced argument, the instructions are to cause programmable circuitry to compute an exponential value of a second portion of the second range reduced argument, corresponding to most significant bits of the first range reduced argument, based on a look-up table.

13. The non-transitory machine readable storage medium of claim 10, wherein the instructions are to cause programmable circuitry to approximate the exponential value of the input using fixed point arithmetic and outputs the exponential value of the input in a fixed point representation.

14. The non-transitory machine readable storage medium of claim 10, wherein the instructions are to cause programmable circuitry to determine the accuracy control value based on obtaining a product of the input and a constant, and rounding that product to a nearest integer.

15. The non-transitory machine readable storage medium of claim 10, wherein the instructions are to cause programmable circuitry to shift the exponential value of the second range reduced argument left or right by a number of positions equal to the accuracy control value to compute the exponential value of the input, wherein a left shift corresponds to a positive accuracy control value and a right shift corresponds to a negative accuracy control value.

16. The non-transitory machine readable storage medium of claim 10, wherein the instructions are to cause programmable circuitry to use a polynomial-based approximation function to approximate the exponential value of the portion of the second range reduced argument.

17. The non-transitory machine readable storage medium of claim 10, wherein the instructions are to cause programmable circuitry to compute the exponential value of the input based on the accuracy control value and an approximated exponential value of the first range reduced argument.

18. The non-transitory machine readable storage medium of claim 10, wherein the instructions are to cause programmable circuitry to use an iteration-based approximation function to approximate the exponential value of the portion of the second range reduced argument.

19. A system to perform an exponential function of a neural network comprising:
interface circuitry to obtain an input;
programmable circuitry to:
determine a fixed point value from the input;
determine, based on the fixed point value, a first range reduced argument and an accuracy control value for an approximation of the exponential function of the neural network;
determine, based on the first range reduced argument, a second range reduced argument for the approximation of the exponential function, the second range reduced argument having a smaller data range than the first range reduced argument; and
compute an exponential value of the fixed point value based on the accuracy control value and an exponential value of the second range reduced argument, wherein the accuracy control value identifies a number of polynomial terms used to approximate an exponential value of a portion of the second range reduced argument.

20. The system of claim 19, wherein the programmable circuitry is to approximate the exponential value of the fixed point value using fixed point arithmetic.
